(19) United States
(12) Patent Application Publication
(10) Pub. No.: US 2021/0234919 A1
(43) Pub. Date: Jul. 29, 2021

(54) SYSTEMS AND METHODS FOR LIVE PERFORMANCE MAPPING OF COMPUTING ENVIRONMENTS

(71) Applicant: Citrix Systems, Inc., Fort Lauderdale, FL (US)

(72) Inventors: Hrushikesh Shrinivas Paralikar, Milpitas, CA (US); Kenneth Bell, Sunnyvale, CA (US); Arkesh Kumar, San Jose, CA (US); Anil Kumar Gavini, Santa Clara, CA (US)

(21) Appl. No.: 16/750,727

(22) Filed: Jan. 23, 2020

(51) Int. Cl. H04L 29/08; H04L 12/26

(52) U.S. Cl. CPC H04L 67/101; H04L 43/0864; H04L 67/2814; H04L 67/125

(57) ABSTRACT

Described implementations provide systems and methods generating and using live performance maps of a network environment for selecting combinations of proxies and servers for fulfilling client device requests. Proxy devices or connectors may gather network telemetry data from actual network flows between client devices and application servers or other resources traversing the proxy devices or connectors, when available, or by generating synthetic transactions to measure network telemetry data when actual flows are unavailable. The telemetry data may be provided to a management service, which may generate a performance map. The performance map may be provided to the proxy devices and/or a cloud proxy service for selection of optimal combinations of connectors and resources for client requests. Incoming client requests may be steered or redirected to the selected optimal combination. The performance map may be dynamically regenerated as network conditions change and/or as servers are deployed or undeployed.

### FIELD OF THE DISCLOSURE

The present application generally relates to network communications, including but not limited to systems and methods for controlling network access to application servers or other computing environments.

### BACKGROUND

As the workforce of an enterprise becomes more mobile and work under various conditions, an individual can use one or more client devices, including personal devices, to access network resources such as web applications. Due to differences between the client devices and the manner in which network resources can be accessed, there are significant challenges to the enterprise in managing access to network resources and monitoring for potential misuse of resources.

Client computing device access to different application servers, data servers, or other resources may be provided via one or more proxy devices, sometimes referred to as connectors, which may be deployed at various locations, including data centers, enterprise branch or main offices, or other locations. In many instances, latencies or network performance between proxy devices and computing resources may vary, and may also dynamically change as various resources are utilized. Simple routing systems or load balancing schemes may be inadequate to cope with these changing characteristics. Specifically, improper selection of connectors or proxies and servers or resources may result in traffic delays, latency, and degraded throughput for client devices.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure addresses the problems discussed above by building a live performance map of the network environment and using it in selecting combinations of proxies and servers for fulfilling client device requests. Proxy devices or connectors may gather network telemetry data from actual network flows between client devices and application servers or other resources traversing the proxy devices or connectors, when available, or by generating synthetic transactions to measure network telemetry data when actual flows are unavailable. The telemetry data may be provided to a management service, which may generate a score table or heat map representing performance of each combination of connector and resource, referred to generally as a performance map. The performance map may be provided to the proxy devices and/or a cloud proxy service for selection of optimal combinations of connectors and resources for client requests. Incoming client requests may be steered or redirected to the selected optimal combination. The performance map may be dynamically regenerated as network conditions change and/or as servers are deployed or undeployed.

In one aspect, this disclosure is directed to a method for connection management. The method includes measuring, by a proxy device deployed at a data center, performance telemetry between the proxy device and each of one or more application servers. The method further includes transmitting, by the proxy device to a management service, the measured performance telemetry. The method further includes receiving, by one of the proxy device or a proxy cloud service from the management server, an array comprising performance scores for each combination of an application server of the one or more application servers and one of the proxy device or another proxy device. The method further includes receiving, by one of the proxy device or the proxy cloud service, a connection request from a client device directed to a first application server of the one or more application servers. The method further includes selecting, by the one of the proxy device or the proxy cloud service from the array, a proxy device associated with a highest performance score for the first application server. The method further includes steering, by the one of the proxy device or the proxy cloud service, the connection request to the selected proxy device.

In some implementations, the performance telemetry data comprises latency between each proxy device and each of the one or more application servers. In a further implementation, at least a portion of the performance telemetry data is measured according to a round trip time of a request and response of a synthetic transaction communicated between a proxy device an application server. In another further implementation, at least a portion of the performance telemetry data is measured according to a round trip time of a request and response of an existing communication session between a client device and an application server traversing a proxy device. In still another further implementation, the performance scores are inversely proportional to the performance telemetry.

In some implementations, steering the connection request further comprises forwarding the connection request to the selected proxy device. In some implementations, steering the connection request further comprises transmitting a redirection command to the client device.

In another aspect, this disclosure is directed to a system for connection management. The system includes a cloud proxy service comprising a network interface and a processor. The network interface is configured to: receive, from a management service, an array comprising performance scores for each combination of an application server of one or more application servers and a proxy device of one or more proxy devices, the array generated from performance telemetry data measured by each proxy device of the one or more proxy devices for each application server of the one or more application servers; and receive a connection request from a client device directed to a first application server of the one or more application servers. The processor is further configured to: select, from the array, a proxy device of the one or more proxy devices associated with a highest performance score for the first application server; and steer the connection request to the selected proxy device.

In some implementations, the performance telemetry comprises latency between the proxy device and each of the one or more application servers. In a further implementation, at least a portion of the performance telemetry data is measured according to a round trip time of a request and response of a synthetic transaction communicated between a proxy device an application server. In another further implementation, at least a portion of the performance telemetry data is measured according to a round trip time of a request and response of an existing communication session between a client device and an application server traversing a proxy device. In still another further implementation, the performance scores are inversely proportional to the performance telemetry.

In some implementations, the network interface is further configured to forward the connection request to the selected proxy device. In some implementations, the network interface is further configured to transmit a redirection command to the client device.

In another aspect, this disclosure is directed to a method for providing resources to client devices. The method includes receiving, by a management service from each of a plurality of proxy devices, performance telemetry between the corresponding proxy device and each of one or more application servers. The method further includes generating, by the management service, an array comprising performance scores for each combination of application server and proxy device. The method further includes providing, by the management service, the generated array to each proxy device or to a cloud proxy service, wherein a proxy device or the cloud proxy service steers a connection of a first client device directed to a first application server via a proxy device associated with a highest performance score for the first application server according to the generated array.

In some implementations, the performance telemetry comprises latency between the corresponding proxy device and each of the one or more application servers. In a further implementation, the latency is measured via synthetic transactions transmitted by the corresponding proxy device to each of the one or more application servers. In another further implementation, the latency is measured via monitoring of requests and responses of an existing connection between the proxy device and each of the one or more application servers. In yet another further implementation, the performance scores are inversely proportional to the performance telemetry. In some implementations, a plurality of proxy devices and a plurality of application servers are deployed at a first data center.

### BRIEF DESCRIPTION OF THE DRAWING FIGURES

Objects, aspects, features, and advantages of implementations disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating implementations, principles and concepts. The drawings are not intended to limit the scope of the claims included herewith.

FIG. 1A is a block diagram of implementations of a computing device;

FIG. 1B is a block diagram depicting a computing environment comprising client device in communication with cloud service providers;

FIG. 2A is a block diagram depicting an implementation of a computing environment for live performance mapping;

FIG. 2B is a table depicting an example of a performance map, according to some implementations;

FIG. 2C is a block diagram depicting another implementation of a computing environment for live performance mapping of computing environments;

FIG. 3 is a block diagram depicting an implementation of a system for live performance mapping of computing environments;

FIG. 4A is a flow diagram of an implementation of a method for live performance mapping of computing environments; and

FIG. 4B is a flow diagram of an implementation of a method for redirecting or steering communications based on live performance mapping of computing environments.

### DETAILED DESCRIPTION

Client computing device access to different application servers, data servers, or other resources may be provided via one or more proxy devices, sometimes referred to as connectors, which may be deployed at various locations, including data centers, enterprise branch or main offices, or other locations. In many instances, latencies or network performance between proxy devices and computing resources may vary. For example, a first proxy device may be located geographically proximate to an application server, while a second proxy device is located at a distance, and has a higher latency for communications to the application server.

In many implementations, particularly with resources deployed in a cloud environment, network performance between resources may dynamically vary. For example, rather than a first application server being a physical server, the application server may be a virtual server provided by one or more physical computing devices deployed at various data centers. For example, the application server may be provided by a first physical computing device at a first data center at one time, and a second physical computing device at a second data center at another time. Similarly, proxy devices may be provided by virtual network devices in some implementations. Accordingly, latencies and other network performance characteristics may dynamically change as various virtual or cloud resources are utilized. Simple routing systems or load balancing schemes may be inadequate to cope with these changing characteristics. Specifically, improper selection of connectors or proxies and servers or resources may result in traffic delays, latency, and degraded throughput for client devices.

The present disclosure addresses these and other problems by building a live performance map of the network environment and using it in selecting combinations of proxies and servers for fulfilling client device requests. Proxy devices or connectors may gather network telemetry data from actual network flows between client devices and application servers or other resources traversing the proxy devices or connectors, when available, or by generating synthetic transactions to measure network telemetry data when actual flows are unavailable. The telemetry data may be provided to a management service, which may generate a score table or heat map representing performance of each combination of connector and resource, referred to generally as a performance map. The performance map may be provided to the proxy devices and/or a cloud proxy service for selection of optimal combinations of connectors and resources for client requests. Incoming client requests may be steered or redirected to the selected optimal combination. The performance map may be dynamically regenerated as network conditions change and/or as servers are deployed or undeployed.

For purposes of reading the description of the various implementations below, the following descriptions of the sections of the specification and their respective contents may be helpful:

Section A describes a computing environment which may be useful for practicing implementations described herein; and

Section B describes systems and methods for live performance mapping of computing environments.

### A. Computing Environment

Prior to discussing the specifics of implementations of the systems and methods of live performance mapping of computing environments, it may be helpful to discuss the computing environments in which such implementations may be deployed.

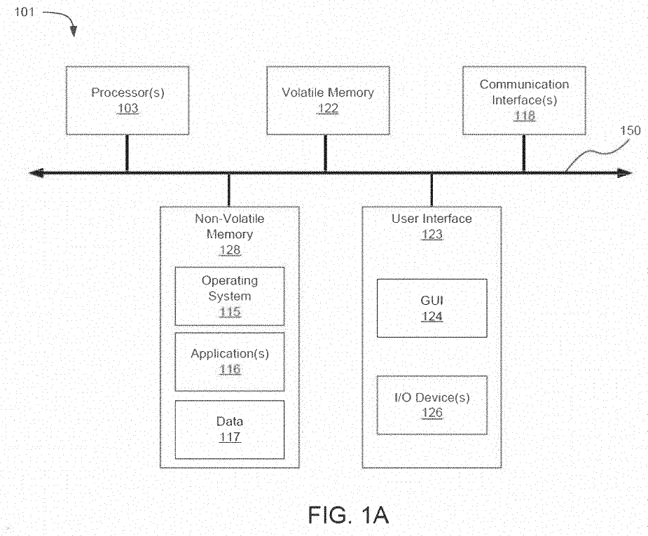

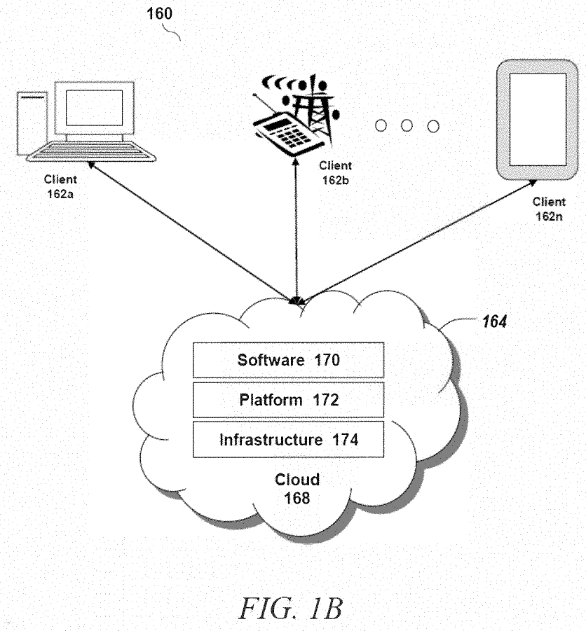

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some implementations, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some implementations, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some implementations, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described implementations, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In implementations, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In implementations, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In implementations, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some implementations, the computing environment 160 can include or provide monitoring services to monitor, control and/or generate reports corresponding to the provided shared services and resources.

In some implementations, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g. Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some implementations, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some implementations, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods for Live Performance Mapping of Computing Environments

The present disclosure is directed towards systems and methods for live performance mapping of computing environments. Client computing device access to different application servers, data servers, or other resources may be provided via one or more proxy devices, sometimes referred to as connectors, which may be deployed at various locations, including data centers, enterprise branch or main offices, or other locations. In many instances, latencies or network performance between proxy devices and computing resources may vary. For example, a first proxy device may be located geographically proximate to an application server, while a second proxy device is located at a distance, and has a higher latency for communications to the application server.

In many implementations, particularly with resources deployed in a cloud environment, network performance between resources may dynamically vary. For example, rather than a first application server being a physical server, the application server may be a virtual server provided by one or more physical computing devices deployed at various data centers. For example, the application server may be provided by a first physical computing device at a first data center at one time, and a second physical computing device at a second data center at another time. Similarly, proxy devices may be provided by virtual network devices in some implementations. Accordingly, latencies and other network performance characteristics may dynamically change as various virtual or cloud resources are utilized. Simple routing systems or load balancing schemes may be inadequate to cope with these changing characteristics. Specifically, improper selection of connectors or proxies and servers or resources may result in traffic delays, latency, and degraded throughput for client devices.

The present disclosure addresses these and other problems by building a live performance map of the network environment and using it in selecting combinations of proxies and servers for fulfilling client device requests. Proxy devices or connectors may gather network telemetry data from actual network flows between client devices and application servers or other resources traversing the proxy devices or connectors, when available, or by generating synthetic transactions to measure network telemetry data when actual flows are unavailable. The telemetry data may be provided to a management service, which may generate a score table or heat map representing performance of each combination of connector and resource, referred to generally as a performance map. The performance map may be provided to the proxy devices and/or a cloud proxy service for selection of optimal combinations of connectors and resources for client requests. Incoming client requests may be steered or redirected to the selected optimal combination. The performance map may be dynamically regenerated as network conditions change and/or as servers are deployed or undeployed.

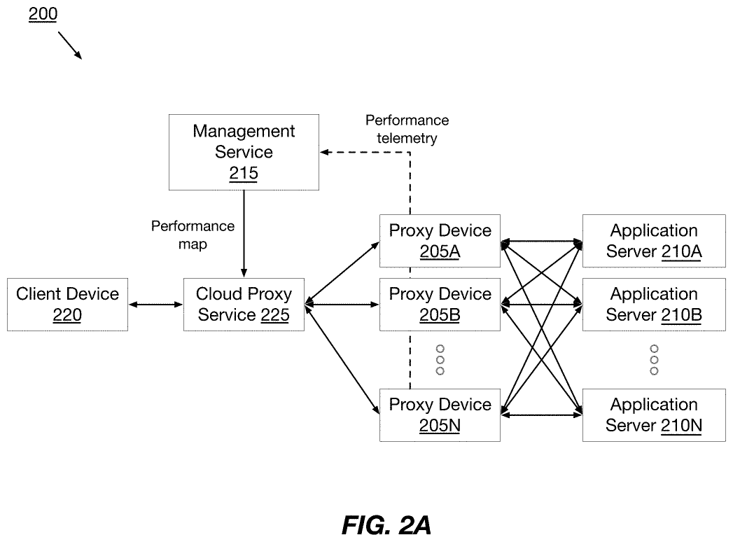

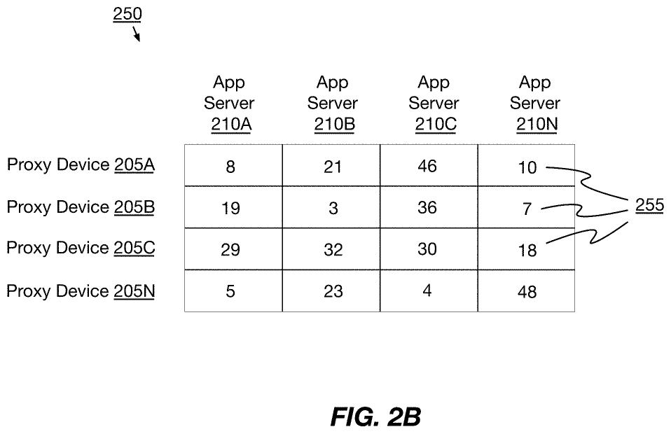

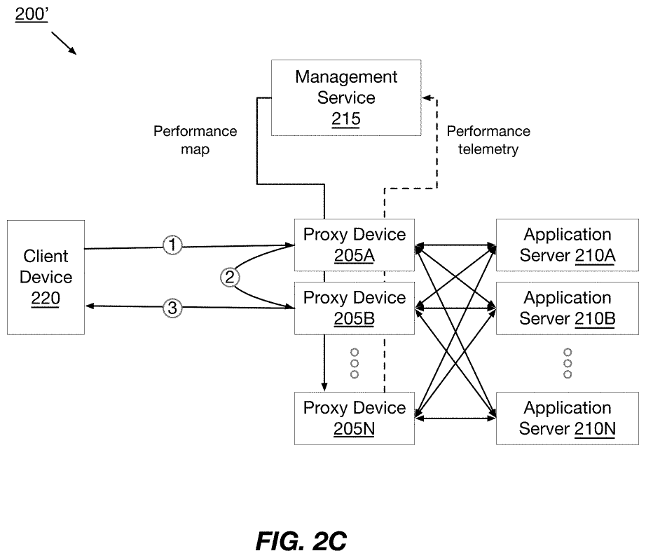

Referring first to FIG. 2A, in brief overview, depicted is a block diagram of a computing environment 200 for live performance mapping. The computing environment 200 may comprise one or more client devices 220 communicating with one or more application servers 210A-210N (referred to generally as application server(s) 210) via a cloud proxy service 225 and one or more proxy devices 205A-205N (referred to generally as proxy device(s) 205). A management service 215 may collect performance telemetry data from proxy device(s) 205, and provide a performance map to cloud proxy service 225.

Still referring to FIG. 2A and in more detail, a client device 220 may include a laptop computer, desktop computer, tablet computer, wearable computer, smartphone, embedded computer, smart appliance, or any other type and form of computing device capable of communicating over a network with an application server. Client device 220 may comprise one or more processors executing one or more applications for communicating with an application server, such as a web browser application, a remote desktop application, a mail application, a media player application, or any other type and form of application. In many implementations, a client device 220 may transmit a request to a cloud proxy service 225 and/or a proxy device 205 to connect to an application server 210 of a plurality of application servers 210A-210N. In many implementations, the request may not identify a specific application server 210, but may instead identify a group of servers, an application or function (e.g. remote desktop, virtual environment, hosted application, etc.) provided by each of a plurality of servers, or otherwise identify a computing environment rather than a specific server device. The proxy device or cloud proxy service may select a combination of proxy device and application server to provide a most optimal experience.

A proxy device 205 may include an intermediary device used to facilitate the data flow between application server(s) 210 and client(s) 220. A proxy device 205 may comprise a hardware device, such as a load balancer, gateway, router, switch, firewall, or other such appliance, and may be deployed at a data center, enterprise location, branch office, or other such location. In many implementations, a proxy device 205 may refer to a cluster or group of appliances configured to work together as a single virtual device. In some implementations, a proxy device 205 may comprise a virtual computing device or appliance provided by a physical computing device. A proxy device 205 may comprise one or more processors, one or more memory devices, and one or more network interfaces, such as those discussed above in connection with section A. In some implementations, each proxy device 205A-210N may measure performance telemetry between said proxy device and each application server 210A-210N (e.g. between proxy device 205A and server 210A, between proxy device 205A and server 210B, and between proxy device 205A and server 210N by proxy device 205A; between proxy device 205B and server 210A, between proxy device 205B and server 210B, and between proxy device 205B and server 210N by proxy device 205B; etc.). Each proxy device 205 may transmit the measured telemetry data to management server 215 for aggregation with telemetry data from other proxy devices 205. In some implementations, each proxy device 205 may receive aggregated performance data from the management server 215 identifying or comparing performance of combinations of proxy devices (including the proxy device 205) and application servers.

As shown, in many implementations, proxy devices 205A-205N may be managed by a cloud proxy service 225. Cloud proxy service 225 may comprise a first proxy device acting as a manager or master of a plurality of additional proxy devices, or may comprise a separate computing device (e.g. a load balancer, redirector, switch, proxy, etc.) acting as an intermediary between client devices 220 and proxy devices 205. For example, a cloud proxy service 225 may receive a request to access an application server 210 from a client device 220 and may select a proxy device 205 to serve as an intermediary for the flow between client device 220 and application server 210. The cloud proxy service 225 may forward or redirect the request to the selected proxy device, or may direct the client and/or selected proxy device to establish communications. The cloud proxy service 225 may select a proxy device and application server to fulfill a client request according to a performance map received from management service 215. Specifically, in many implementations, the client request may not identify a particular server, but rather may identify an application, virtual environment, remote desktop, or other such functionality provided by each of a plurality of servers 210. The cloud proxy service 225 may select a combination of a proxy device 205 and an application server 210 based on the performance map received from the management server 215 (e.g. a highest performing server and proxy combination, a lowest latency server or one having a lowest latency connection to a proxy, a server and proxy having a highest reliability connection, etc.). In some implementations, the request may identify a particular server, and the cloud proxy service 225 may select a different server to fulfill the request based on the performance data.

An application server 210 may comprise a server with an ability to operate and host remote applications such as web applications, webmail, online forms, word processors, spreadsheets, etc., remote desktop applications or hosted desktops, network accessible databases, computation servers, or any other type and form of server. Although referred to as an application server, in many implementations, the server may comprise or be referred to as a web server, FTP server, data server, mail server, or any other type and form of resource. An application server 210 may comprise a desktop computer, rackmount computer, blade server, or any other type of computing device. In some implementations, an application server 210 may comprise one or more virtual machines executed by one or more physical computing devices, such as a cloud server. Application server 210 may comprise one or more devices and may be aggregated in a server farm, a server cluster, a server cloud, or any other such format. Application server 210 may execute one or more applications to provide web applications, such as a web server, HTTP server, FTP server, remote desktop server, data server, or other type and form of server application. The application server 210 may connect with and communicate to a plurality of proxy devices 205 via one or more networks. In many implementations an application server 210 may be co-located with a proxy device 205 (e.g. at a data center).

A management server 215 may comprise a rackmount server, desktop server, workstation, virtual machine executed by one or more physical machines, appliance, or other computing device for receiving performance telemetry data from one or more proxy devices 205 and for aggregating telemetry data into a performance score board, score table, performance heatmap, or similar structure, referred to generally as a performance map. The management server 215 may transmit the performance map to each of one or more proxy devices 205 and/or cloud proxy service 225, to allow the proxy devices 205 and/or service 225 to select optimal combinations of proxy devices and application servers to fulfill client requests.

FIG. 2B is a table depicting an example of a performance map 250, according to some implementations. The performance map 250 may identify combinations of application servers 210A-210N and proxy devices 205A-205N. Although shown as a table, the performance map 250 may be provided in any suitable format, including as a data array, bitmap (e.g. with pixel values corresponding to measurement values, etc.), flat file, spreadsheet, or other data structure. The performance map 250 may include values 255 representing performance scores for each combination of proxy device and application server. The performance scores may be based on one or more telemetry measurements, including latency of communications (e.g. round trip times) between each combination of proxy device and application server, average CPU or memory utilizations (e.g. an weighted or unweighted average of the CPU utilization of an application server and a proxy device, etc.), a number of active connections between the proxy device and application server, a packet loss rate between the proxy device and application server, etc. In some implementations, the performance scores may be based on a combination of any of these or other measurements. For example, a score may be generated as a weighted sum of an average CPU utilization, a connection latency, a buffer status, and a predetermined value selected responsive to having a number of active connections below a threshold level. In various implementations, higher or lower scores may be preferable (e.g. a higher score may represent better performance in some implementations, while in other implementations, a lower score may represent better performance).

As shown in the example provided, different combinations of proxy devices and application servers may have different associated scores, such that a combination of a first proxy device (e.g. proxy device 205B) and first server (e.g. app server 210B) may have a lowest score, while the same proxy device may have significantly higher scores in association with other application servers. This may be a result of load on those servers, geographic distances between the proxy device and those servers, or other such reasons.

As discussed above, in some implementations, a proxy device 205 may act as the redirector or cloud proxy service. FIG. 2C is a block diagram depicting another implementation of a computing environment for live performance mapping with proxy device(s) receiving client requests directly. In the implementation illustrated, a request to access an application may be received from a client device 220 by a first proxy device 205A (shown as communication 1). Each proxy device 205, in addition to providing performance telemetry to management service 215, may also receive the performance map. The first proxy device 205A may consult the performance map and determine that a combination of another proxy device and application server (e.g. proxy device 205B and application server 210A) has a best or most optimal score for fulfilling the client request. The first proxy device 205A may redirect the request to the second proxy device 205B (e.g. by forwarding the request or transmitting a new request to establish communications between the proxy device 205B and client device 220), shown as communication 2. The second proxy device may then establish communications with the client device 220 (shown as communication 3). Although shown with communication 2 going from the first proxy device to the second proxy device, in some implementations, the redirection communication may be transmitted from the proxy device 205A to the client device 220 (e.g. an HTTP redirect code or similar communication identifying the second proxy device), which may then retransmit the request to the second proxy device 205B. As the second proxy device 205B has the same performance map, it will similarly identify the same combination of proxy device and application server (e.g. proxy device 205B and application server 210A) and proceed to provide the requested communication, without further redirection. To prevent multiple redirections in instances where a first proxy device has a first performance map and a second proxy device has an older performance map that identifies different optimal combinations, in some implementations, performance maps may be associated with active or start times (e.g. allowing the management service to transmit performance maps to each proxy device from time t0 to t1, with the maps made “active” by each proxy device at a subsequent time t2).

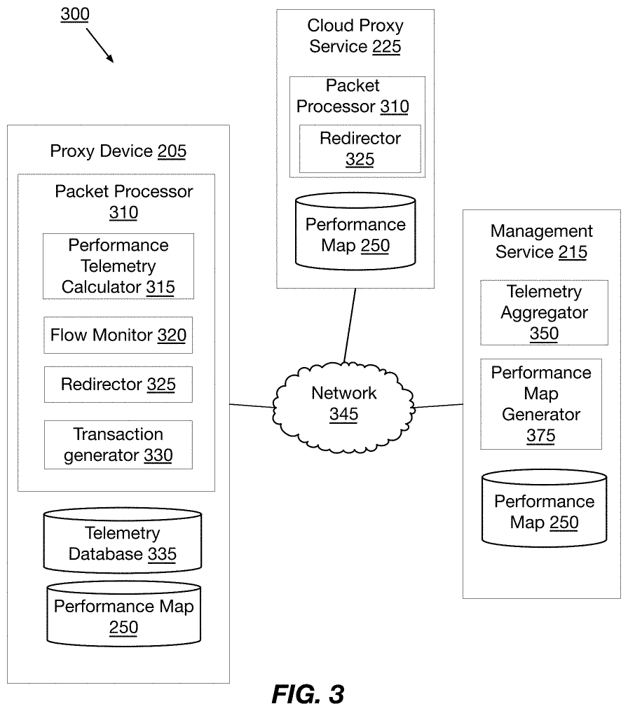

FIG. 3 is a block diagram depicting an implementation of a system 300 for live performance mapping of computing environments. Proxy device(s) 205 may comprise one or more processors, one or more memory devices, and one or more network interfaces (not illustrated). The proxy device 205 may comprise a hardware device, such as a load balancer, gateway, router, switch, firewall, or other such appliance, and may be deployed at a data center. In many implementations, a proxy device 205 may refer to a cluster or group of appliances configured to work together as a single virtual device. In some implementations, a proxy device 205 may comprise a virtual computing device or appliance provided by a physical computing device. The proxy device 205 may comprise or execute a packet processor 310, which may comprise a portion of a network stack of an operating system of the proxy device, or may refer to a co-processor (e.g. of a network interface card). The packet processor 310 may perform telemetry measurements and monitoring, as well as providing proxying and redirection services for communications flows between client devices and application servers traversing the proxy device.

For example, in some implementations, packet processor 310 may comprise a performance telemetry calculator 315 for calculating telemetry measurements between the proxy device and each application server. Performance telemetry calculator 315 may be provided in hardware or software, or a combination of hardware and software (e.g. FPGA, ASIC, or other circuitry, or software of a network stack). Performance telemetry calculator 315 may comprise an application, server, service, daemon, routine, or other executable logic for measuring performance of a combination of the proxy device and an application server (e.g. latency, CPU or memory utilization, buffer status, bandwidth, packet loss, number of active connections, etc.). In some implementations, performance telemetry calculator 315 may provide all measurements or metrics to the management service, while in other implementations, performance telemetry calculator 315 may generate a score locally based off the telemetry measurements. This may reduce the bandwidth needed to communicate with the management service, and may allow for faster updates in some implementations.

As discussed above, proxy devices 205 may measure performance data of application servers and communications with application servers. In some implementations, this may be done by monitoring active connections. For example, if a first client device is communicating via a proxy with a first application server, the proxy may be able to monitor requests and responses traversing the proxy device, e.g. to measure round trip latency time, packet loss rates, bandwidth, jitter, or other such features. In some implementations, additional telemetry data may be appended to such communications. For example, in one such implementations, telemetry data may be appended to an option fields in a network or transport layer header by the application server and, in some implementations, removed by the proxy device, allowing for monitoring to be performed transparently to the client device. Such telemetry data may include CPU or memory utilization of the application server, a count of active connections, etc.

To monitor active connections, proxy device 205 or packet processor 310 may comprise a flow monitor 320. Flow monitor 320 may comprise an application, server, service, daemon, routine, or other executable logic for performing telemetry measurements on traffic between clients and application servers traversing the proxy device 205. For example, during an established connection between a client and application server, packets comprising requests and responses or other exchanged data (sometimes referred to as “real” transactions or “live” transactions) may be transmitted from the client to the proxy device and from the proxy device to the application server and vice versa. The proxy device may record transmission times of requests transmitted or forwarded by the proxy device to the application server, and may record receipt times of responses to the requests from the application server, providing a measure of round trip communications time (including processing time by the application server, such as time to generate responses, time to retrieve data, etc.). Similarly, the proxy device may track transmitted and acknowledged packets to track packet loss rates on the connection between the proxy device and application server. The proxy device may also keep a record of a number of active connections (e.g. from additional clients, for example) between the proxy device and each application server. As noted above, the proxy device may also receive telemetry data from the application servers, such as embedded in packet headers (e.g. options fields of the transport or network layers) or in management packets (e.g. SNMP packets, HTTP RESTful packets with parameter-value pairs in a URL, etc.). The telemetry may be stored in memory of the proxy device 205, such as in telemetry database 335, which may comprise an array, flat file, XML data, or any other type and form of data structure.

In other implementations, such as where active connections between the proxy device and an application server are unavailable or live transactions are unavailable for monitoring, the proxy device may generate traffic (sometimes referred to as “synthetic transactions”) for telemetry measurement purposes. Synthetic transactions may comprise simple requests and responses, such as network pings that may be used to measure round trip times and packet loss rates, and/or may resemble actual traffic to allow for further testing of communications. For example, in some implementations, the proxy device may transmit a synthetic request to access a web application on behalf of a hypothetical client device, such that the application server may instantiate a session for the hypothetical client device and respond with data of the web application. This may be useful for more accurately measuring round trip time or latency to the server including processing time required to generate and serve web applications or other data. Similarly, in some implementations, the proxy device may transmit a request for a large file (e.g. LOMB, 100 MB, 1 GB, or any other such size) to allow measurement of bandwidth and/or throttling of network speeds. Such data may be discarded after receipt, in many instances.

Accordingly, the proxy device 205 and/or packet processor 310 may comprise a transaction generator 330, which may comprise an application, service, server, daemon, routine, or other executable logic for generating and transmitting synthetic transactions to one or more application servers. Performance telemetry calculator 315 may measure performance of the network connections and/or application servers as discussed above, via the synthetic transactions.

As discussed above in connection with FIG. 2C, in some implementations, proxy devices 205 may receive requests from client devices and, via consultation of performance map 250 received from a management service 215, may determine a best combination of proxy device and application server to fulfill the client request (e.g. having a highest performance score, or lowest latency or other such metric). In such implementations, the proxy device may comprise or execute a redirector 325, which may comprise an application, server, service, routine, or other executable logic for receiving requests and redirecting the request, if necessary, to another proxy device. In some implementations as discussed above, the redirector 325 may transmit a request to the selected proxy device to establish a connection with the client device to respond to the request (e.g. by forwarding the request, in some implementations), and/or may request the selected proxy device to establish a connection to the application server on behalf of the client device and respond directly to the client device. In other implementations as discussed above, the redirector 325 may respond to the client with a redirection command (e.g. HTTP redirection code) identifying the selected proxy device, such that the client may retransmit the request the selected proxy device. Similarly, in some implementations, the redirector 325 may determine from the performance map 250 that the best combination of proxy device and application server includes the proxy device executing the redirector, and that no redirection is necessary; in such instances, the packet processor 310 may continue processing the request normally (e.g. by forwarding the request to the selected application server, establishing or reusing a transport layer connection to the application server, etc.).

As discussed above, in some implementations, a cloud proxy service 225 may receive incoming requests from client devices, select a proxy device and application server, and forward the request to the selected proxy device for establishing the connection. Accordingly, in such implementations, cloud proxy service 225 may comprise a packet processor 310, a redirector 315, and a local copy of a performance map 250 received from management service 215. As discussed above, redirector 315 may receive client requests to connect to an application server, may determine a best copy of proxy device and application server to fulfill the request, and may redirect the request to the selected proxy device (e.g. forwarding the request to the proxy device, responding to the client with a redirection command, etc.).

Management service 215 may comprise or execute a telemetry aggregator 350. Telemetry aggregator 350 may comprise an application, server, service, daemon, routine, or other executable logic for aggregating telemetry measurements from one or more proxy devices 205 for connections with application servers, including aggregating past measurements. For example, in some implementations, telemetry aggregator 375 may determine a weighted average of newly received telemetry data and previously received telemetry data (e.g. wₙ*dataₘ+wₙ₋₁*dataₘ₋₁+wₙ₋₂*dataₘ₋₂+ . . . etc., where wₙ equals a weight for measurements at time n, and dataₘ equals measurement data at time n). This may provide some hysteresis or smoothing of highly variable data. In other implementations, this smoothing may be performed by the proxy device(s) prior to transmission of telemetry data to the management service 215. In some implementations, telemetry aggregator may apply one or more normalization, scaling, or similar pre-processing functions to telemetry data in order to combine the data into a score. For example, some telemetry measurements have optimally low values (e.g. latency, packet loss rate, jitter, etc.) while other measurements have optimally high values (e.g. bandwidth, buffer availability, congestion window size, etc.). These measurements may also have drastically different scales (e.g. from milliseconds for latency to megabits or gigabits per second for bandwidth to 0-100% for CPU utilization, etc.). Accordingly, in some implementations, the telemetry aggregator may apply scaling or normalization to consistent scales (e.g. 0-1, 0-100, etc.) as well as inverting values such that all telemetry data has the same optimal values (e.g. just high or low, rather than both). Telemetry aggregator may also combine the telemetry data to generate a single score value representing the quality of the proxy-application server pair, in some implementations. For example, telemetry aggregator may generate a score as a weighted sum of normalized or scaled telemetry data. The weights may reflect the importance of various telemetry values to user experience (for example, depending on the application utilized, bandwidth may be more important than latency for large data transfers; or latency and jitter may be more important for responsiveness of a user interface or real time communications, with packet loss rates being less important). Weighting and combining functions may be different for different applications or classes of applications (e.g. web browsing, mail, video conferencing, video games, etc.). In other implementations, only a single telemetry measurement may be used, and no scaling or aggregation may be necessary. For example, in some implementations, the scores may comprise round trip communication times in milliseconds for each combination of proxy and server. In a similar implementation, scores may be based on a single value, but may still be aggregated over time to provide hysteresis, as discussed above (for example, each score may be a weighted average of measurements of round trip communication time; no scaling or normalization may be required, and the telemetry aggregator may simply perform the averaging calculations).

Management service 215 may also comprise a performance map generator 375. Performance map generator 375 may comprise an application, server, service, daemon, routine, or other executable logic for generating a performance map 250 from aggregated telemetry data. Although shown separately, in many implementations, telemetry aggregator 350 and performance map generator 375 may be part of the same application or routine. Performance map generator 375 may comprise functionality for generating and/or updating a performance map, such as a data array, spreadsheet, bitmap, or other data structure as discussed above, and for providing the performance map 250 to each proxy device 205 and/or a cloud proxy service 225.

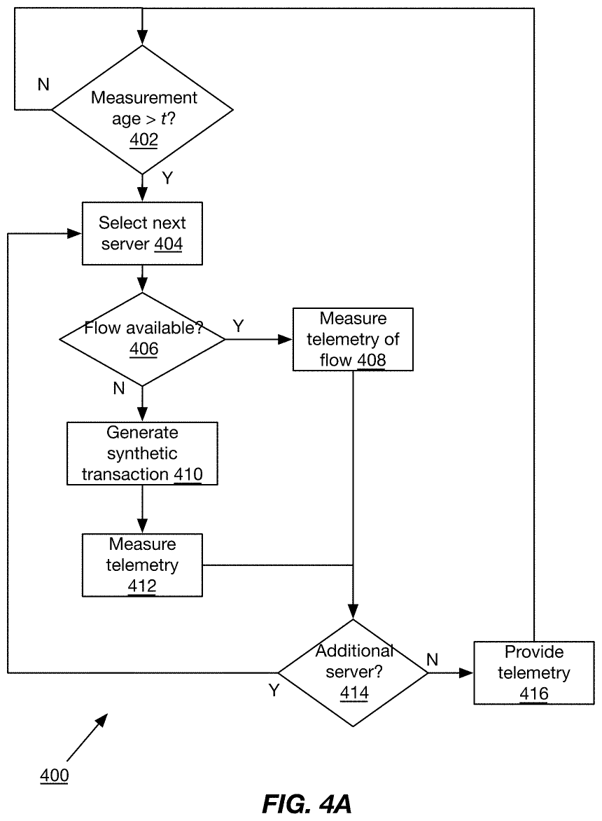

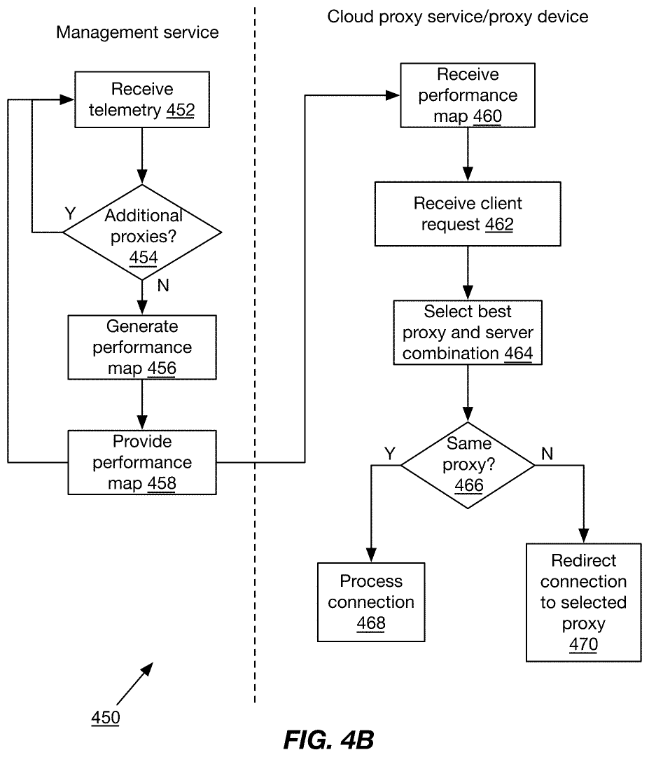

FIG. 4A is a flow diagram of an implementation of a method 400 for live performance mapping of computing environments. The method 400 may be performed synchronously or asynchronously by each of a plurality of proxy devices. In some implementations, at step 402, the proxy device may determine whether current measurement telemetry is older than a predetermined threshold value (e.g. 1 minute, 5 minutes, 15 minutes, 1 hour, or any other such value). If not, then the proxy device may wait and repeat step 402. This may be used to limit how often telemetry data is collected and provided to a management service, to reduce bandwidth and processing requirements (for example, continuous monitoring or monitoring every millisecond will take drastically more resources than monitoring every ten minutes). The threshold may be dynamically adjusted by a user or administrator, in many implementations. If no measurement data is present (e.g. the proxy device has not yet acquired telemetry data), then the data may be considered to be infinitely old and/or step 402 may be skipped.

If no measurement data under the age threshold is present, then at step 404, the proxy device may select an application server for which to measure the connection quality and acquire telemetry data. The application server may be selected in a round robin or weighted round robin fashion, a random order, in order by identifier or name, or any other method.

At step 406, the proxy device may determine whether an active or “real” communication flow to the selected application server from a client device is traversing the proxy device. If so, then at step 408, the proxy device may perform telemetry measurements using the requests and responses between the client device and the selected application server (e.g. measuring round trip time based on timestamps of a request and response, measuring packet loss rates based on acknowledgement or negative acknowledgement rates, etc., as well as receiving explicit telemetry data provided by the application server in packet headers, options, or payloads).

Conversely, if no “real” flow is available between a client device and the selected application server, then at step 410, the proxy device may generate one or more synthetic transactions. As discussed above, synthetic transactions may comprise any sort of request, including a ping, a telemetry request, a RESTful HTTP request including parameter-value pairs for telemetry data, a request for data or access to a web application, etc. As discussed above, in some implementations, the synthetic transaction may be indistinguishable from a real transaction from the application server's perspective—that is, the synthetic transaction may be identical to a legitimate request from a client device, such that the application server spends time processing the request as if responding to the client device (e.g. establishing a remote desktop session, instantiating a web application, etc.), allowing for measurement of processing time of the application server (along with round trip communication times, in many implementations). At step 412, the proxy device may measure the telemetry data via receipt of a response to the synthetic transaction.

At step 414, the proxy device may determine if additional application servers are available for which telemetry data has not been measured within the aging time period t. If so, then steps 404-414 may be repeated iteratively for each additional application server. Although shown in serial, in some implementations, steps 404-414 may be performed in parallel for multiple application servers simultaneously (for example, if multiple communications flows to different application servers are traversing the proxy device simultaneously, it may be efficient to measure telemetry data for each flow as responses are received).

At step 416, the proxy device may provide the telemetry data to a management service for aggregation and generating or updating of heat maps. In some implementations, providing the telemetry data may comprise transmitting the raw data or raw measurements (e.g. as a data string, array, XML data, spreadsheet, or in any other format). In other implementations, the proxy device may perform pre-processing on the data before transmission, such as scaling, normalization, inversion, averaging, etc., as discussed above. This may reduce processing requirements on the management service, in some implementations. In other implementations, the management service may have more processing availability than the proxy devices (which are handling communications flows), and thus such pre-processing may occur on the management service after receiving the telemetry data. The proxy device may then return to step 402, and wait until a timer of period t expires or the telemetry data has aged beyond time period t as discussed above.

FIG. 4B is a flow diagram of an implementation of a method 450 for redirecting or steering communications based on live performance mapping of computing environments. As shown, in many implementations, the method includes a first portion performed by a management service, and a second portion performed by a cloud proxy service or proxy device (shown divided by dashed line). At step 452, a management service may receive telemetry data from a proxy device (e.g. transmitted at step 416, discussed above). The management service may store the telemetry data (e.g. in a local database, storage device, or other such structure). In some implementations, the management service may perform additional pre-processing steps on the data, such as normalization, scaling, inversion, temporal aggregation or averaging, etc., as discussed above.

In some implementations, the management service may determine at step 454 whether telemetry data has been received from all proxy devices. If additional proxies have not yet provided telemetry data, then the management service may repeat steps 452-454 in some implementations.

Once telemetry data has been received from all proxies, at step 456, the management service may generate or update a performance map. As discussed above, the performance map may comprise an array, spreadsheet, database, bitmap, or other such data structure, identifying performance scores for each combination of proxy device and application server. At step 458, the management service may provide the performance map to a cloud proxy service and/or one or more proxy devices. The management service may then return to step 452 to receive subsequent telemetry data.

At step 460, the cloud proxy service and/or proxy device(s) may receive the performance map, and may store the map in local memory and/or update a previous map in memory. Subsequently, a cloud proxy service and/or proxy device may receive a request from a client to establish a connection with or access an application server, at step 462. At step 464, the cloud proxy service and/or proxy device may determine, from the performance map, a best combination of proxy and server (e.g. having a highest performance or quality score, a lowest latency, etc.). If the device receiving the request is a proxy device, then at step 466, it may determine whether the best combination of proxy and server includes itself; if so, at step 468, it may process the request normally (e.g. establishing or re-using a connection to the selected application server, forwarding the request of the client, performing other functions such as establishing encryption or compression parameters for the communication flow, etc.). If the best combination does not include the proxy device, then at step 470, the proxy device may redirect the request to the proxy device associated with the selected combination of proxy and application server. Redirecting the request may comprise forwarding the request, responding to the client device with a redirection command, etc., as discussed above. If the device receiving the request is a cloud proxy service or other load balancer or manager of the proxy devices, then in some implementations, steps 466-468 may be skipped, as all such requests will be redirected to a proxy device.

Although discussed above in terms of a single performance map for all proxy devices and application servers, in many implementations, different application servers have different capabilities or provide different functionality. For example, a first set of application servers may provide video conferencing or voice over IP (VoIP) services, while a second set of application servers may provide access to web applications or online storage archives. In some implementations, these different servers may have different “optimal” characteristics (e.g. low latency for real time communications, and high bandwidth for online archives), and accordingly, different performance maps with different scoring functions may be maintained for different sets or classes of application servers. Similarly, in some implementations, certain application servers may be unable to provide certain functionality (e.g. video conferencing functions, access to encrypted data stores, mail, etc.). Even if the same scoring functions are used, different performance maps may be maintained for each application group, to prevent a proxy service or device from accidentally selecting as a best combination a proxy device and application server that is unable to provide the requested application. In such implementations, at step 464, the proxy server or proxy device may identify a requested application or functionality from the client request (e.g. by protocol at the application, session, transport, or network layer; by a URL or URI in a header or payload of the request associated with an application; by metadata in the request; or any other such identifier), and may use a performance map corresponding to the identified application or functionality to select the best combination of proxy device and application server.

Accordingly, the present disclosure provides systems and methods for generating and using live performance maps of a network environment for selecting combinations of proxies and servers for fulfilling client device requests. Proxy devices or connectors may gather network telemetry data from actual network flows between client devices and application servers or other resources traversing the proxy devices or connectors, when available, or by generating synthetic transactions to measure network telemetry data when actual flows are unavailable. The telemetry data may be provided to a management service, which may generate a score table or heat map representing performance of each combination of connector and resource, referred to generally as a performance map. The performance map may be provided to the proxy devices and/or a cloud proxy service for selection of optimal combinations of connectors and resources for client requests. Incoming client requests may be steered or redirected to the selected optimal combination. The performance map may be dynamically regenerated as network conditions change and/or as servers are deployed or undeployed.

Various elements, which are described herein in the context of one or more implementations, may be provided separately or in any suitable subcombination. For example, the processes described herein may be implemented in hardware, software, or a combination thereof. Further, the processes described herein are not limited to the specific implementations described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method for connection management, comprising:
receiving, by a proxy cloud service from a management service, an array comprising performance scores for each combination of an application server of one or more application servers and a proxy device of one or more proxy devices, the array generated from performance telemetry data measured by each proxy device of the one or more proxy devices for each application server of the one or more application servers;
receiving, by the proxy cloud service, a connection request from a client device directed to a first application server of the one or more application servers;
selecting, by the proxy cloud service from the array, a proxy device of the one or more proxy devices associated with a highest performance score for the first application server; and
steering, by the proxy cloud service, the connection request to the selected proxy device.

2. The method of claim 1, wherein the performance telemetry data comprises latency between each proxy device and each of the one or more application servers.

3. The method of claim 2, wherein at least a portion of the performance telemetry data is measured according to a round trip time of a request and response of a synthetic transaction communicated between a proxy device an application server.

4. The method of claim 2, wherein at least a portion of the performance telemetry data is measured according to a round trip time of a request and response of an existing communication session between a client device and an application server traversing a proxy device.

5. The method of claim 2, wherein the performance scores are inversely proportional to the performance telemetry.

6. The method of claim 1, wherein steering the connection request further comprises forwarding the connection request to the selected proxy device.

7. The method of claim 1, wherein steering the connection request further comprises transmitting a redirection command to the client device.

8. A system for connection management, comprising:
a cloud proxy service comprising a network interface and a processor;
wherein the network interface is configured to:
receive, from a management service, an array comprising performance scores for each combination of an application server of one or more application servers and a proxy device of one or more proxy devices, the array generated from performance telemetry data measured by each proxy device of the one or more proxy devices for each application server of the one or more application servers, and
receive a connection request from a client device directed to a first application server of the one or more application servers; and
wherein the processor is further configured to:
select, from the array, a proxy device of the one or more proxy devices associated with a highest performance score for the first application server, and
steer the connection request to the selected proxy device.

9. The system of claim 8, wherein the performance telemetry comprises latency between the proxy device and each of the one or more application servers.

10. The system of claim 9, wherein at least a portion of the performance telemetry data is measured according to a round trip time of a request and response of a synthetic transaction communicated between a proxy device an application server.

11. The system of claim 9, wherein at least a portion of the performance telemetry data is measured according to a round trip time of a request and response of an existing communication session between a client device and an application server traversing a proxy device.

12. The system of claim 9, wherein the performance scores are inversely proportional to the performance telemetry.

13. The system of claim 8, wherein the network interface is further configured to forward the connection request to the selected proxy device.

14. The system of claim 8, wherein the network interface is further configured to transmit a redirection command to the client device.

15. A method for providing resources to client devices, comprising:
receiving, by a management service from each of a plurality of proxy devices, performance telemetry between the corresponding proxy device and each of one or more application servers;
generating, by the management service, an array comprising performance scores for each combination of application server and proxy device; and
providing, by the management service, the generated array to each proxy device or to a cloud proxy service, wherein a proxy device or the cloud proxy service steers a connection of a first client device directed to a first application server via a proxy device associated with a highest performance score for the first application server according to the generated array.

16. The method of claim 15, wherein the performance telemetry comprises latency between the corresponding proxy device and each of the one or more application servers.

17. The method of claim 16, wherein the latency is measured via synthetic transactions transmitted by the corresponding proxy device to each of the one or more application servers.

18. The method of claim 16, wherein the latency is measured via monitoring of requests and responses of an existing connection between the proxy device and each of the one or more application servers.

19. The method of claim 16, wherein the performance scores are inversely proportional to the performance telemetry.

20. The method of claim 15, wherein a plurality of proxy devices and a plurality of application servers are deployed at a first data center.
